(19) United States
(12) Patent Application Publication
(10) Pub. No.: US 2006/0088665 A1
(43) Pub. Date: Apr. 27, 2006

(54) Colored, embossed and printed elongate articles and method and apparatus to color, emboss and print the same

(76) Inventors: Cyrus A. Jabbari, Vienna, VA (US); Edwin Morales, Fresno, TX (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/100,954

(22) Filed: Apr. 6, 2005

Related U.S. Application Data
(63) Continuation-in-part of application No. 10/974,164, filed on Oct. 27, 2004.

(51) Int. Cl. B05D 1/28

(52) U.S. Cl. 427/428.01

(57) ABSTRACT

A method and apparatus for coloring generally elongated or planar articles, such as window blind slats, utilizes a roller, such as an anilox roller, and enclosed doctor blade subassembly for metering an amount of colorant transferred to the object, and a felt-wiper subassembly for removing colorant from a roller, such as a discharge roller. A generally elongated or planar article having a first and second surface treated by coloring, embossing, and/or printing.

### CROSS-REFERENCE TO RELATED APPLICATIONS

This application is a continuation-in-part of and claims priority to U.S. application Ser. No. 10/974,164, filed Oct. 27, 2004, now pending, which application is hereby incorporated by reference to the extent permitted by law.

### BACKGROUND OF THE INVENTION

The present invention relates generally to the coloring of various manufactured articles. More particularly, the present invention relates to methods and apparatus for coloring, embossing and printing the surfaces of home building/improvement, consumer and construction products. These products are generally elongated and/or planar articles, such as vinyl slats used to manufacture window blinds, molding, baseboards, quarter-rounds, gutters, shutters and the like.

Vertical and horizontal blinds are commonly used as treatments for covering openings, windows, doors, and the like. Such blinds are comprised of generally planar slats, which serve several purposes. Typically, the slats are adjustable to selectively filter light or air, for example. Blinds are also used for aesthetic or decorative purposes. The slats used to manufacture blinds can be formed from a number of materials including wood, metal, thermoplastic resins including polyvinyl chloride (PVC) or similar materials. PVC slats are typically formed by selectively extruding or co-extruding molten PVC material to the desired shape.

To add to the aesthetic appearance of the elongated articles, it is common to create unique surfaces on the articles, such as intricate textured, patterned or colored surfaces. Creation of such unique surface textures and patterns are especially beneficial for use with materials, such as metal and PVC, which do not naturally include as aesthetically pleasing appearances as do organic materials, such as wood. The coloring or coating of the article surfaces is extremely desirable because it adds to the aesthetic appearance, as well as increases the durability of the articles.

Methods to apply coloring to the surfaces of such articles are well known. In one such method, a vinyl slat or profile is fed through a machine that includes a series of rollers for embossing and applying a colorant, such as ink, to the surface of the slat. In such a machine the amount of ink applied to the slat is metered through the use of an anilox roller. Maintaining an adequate amount of ink, evenly distributed over the entire surface of the anilox roller is extremely important. Too little or too much ink results in an undesirable final appearance for the slat. In addition, it is important to keep excess ink from building up on other rollers and components of the machine.

There exists a need in the industry for a method and apparatus of in-line coloring, embossing and printing generally elongated or planar objects such that there is no interruption between coloring stations, embossing stations, and printing stations. Moreover, there is also a need for an apparatus that provides ease of interchangeability of various rollers thereby allowing an operator to easily convert a coloring station to a printing station and to add embossing capabilities to either type of station. Finally, there is a need in the art for generally elongated articles, such as vinyl slats used to manufacture window blinds, molding, baseboards, quarter-rounds, gutters, shutters and the like, that are embossed, printed or both thereby providing an aesthetically-pleasing product as well as a durable one.

### BRIEF SUMMARY OF THE INVENTION

Accordingly the present invention comprises methods and apparatus for coloring, embossing, and printing the surfaces of generally elongated or planar articles, such as vinyl slats, moldings, quarter-rounds, shutters and the like. The present invention also includes such generally elongated or planar articles that are printed, embossed, or both.

These and other objects and advantages of the present invention will be classified in the following description of the invention in connection with the drawings, the disclosure and the appended claims, wherein like reference numerals represent like elements throughout. The drawings constitute a part of this application and include exemplary embodiments of the present invention and illustrate various features thereof.

### BRIEF DESCRIPTION OF SEVERAL VIEWS OF THE DRAWING

FIG. 1 is a front perspective view of an ink machine apparatus embodiment of the present invention;

FIG. 2 is a rear perspective view of the ink machine of FIG. 1;

FIG. 3 is a partial front perspective view of the ink machine of FIG. 1 showing the frame unit of the ink machine;

FIG. 4 is an exploded front perspective view of the roller support frame subassembly of the ink machine shown in FIG. 1;

FIG. 5 is a partial front perspective view of the ink machine of FIG. 1 showing an assembled roller unit of the ink machine;

FIG. 6 is an enlarged front perspective view of the roller unit of FIG. 5 showing the gear transmission and roller subassembly for the right half of the ink machine shown in FIG. 1;

FIG. 7 is a front perspective view of an anilox roller and enclosed doctor blade subassembly of the ink machine shown in FIG. 1;

FIG. 8 is a rear perspective view of the anilox roller and enclosed doctor blade subassembly of FIG. 7;

FIG. 9 is a front perspective view of a felt/wiper unit subassembly of the ink machine shown in FIG. 1.

FIG. 10 is a rear perspective view of the felt/wiper unit subassembly of FIG. 9;

FIG. 11 is a partial front perspective view of the ink machine of FIG. 1 showing a bottom roller lift unit subassembly; and

FIG. 12 is a side elevational view of the article of the present invention.

### DETAILED DESCRIPTION OF THE INVENTION

While the present invention may be embodied in many different forms, there is shown in the drawings and discussed herein a specific embodiment with the understanding that the present disclosure is to be considered only as an exemplification of the principles of the invention and is not intended to limit the invention to the embodiments illustrated.

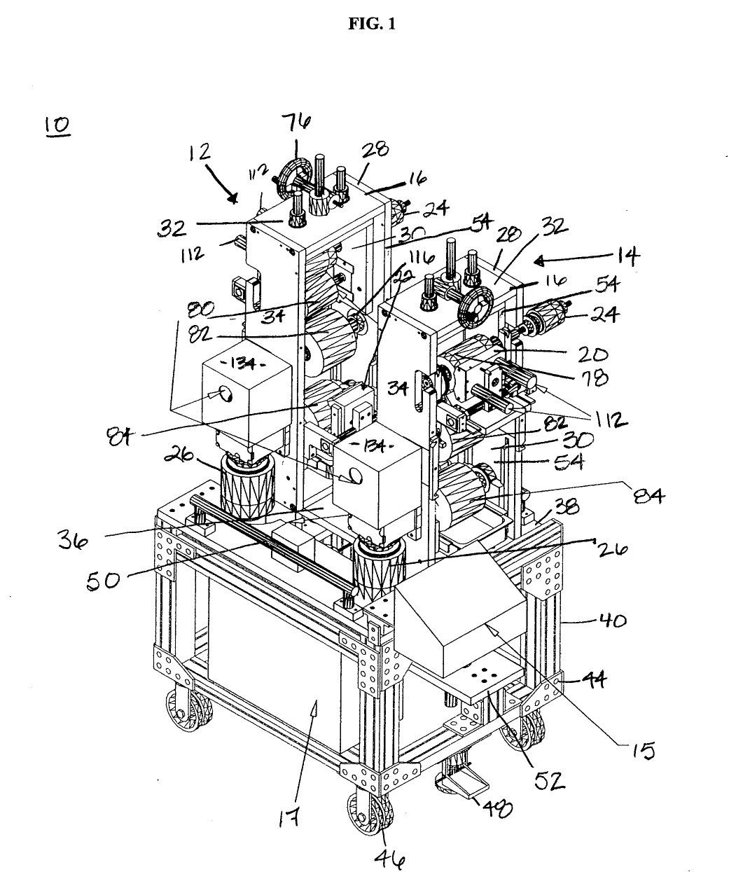

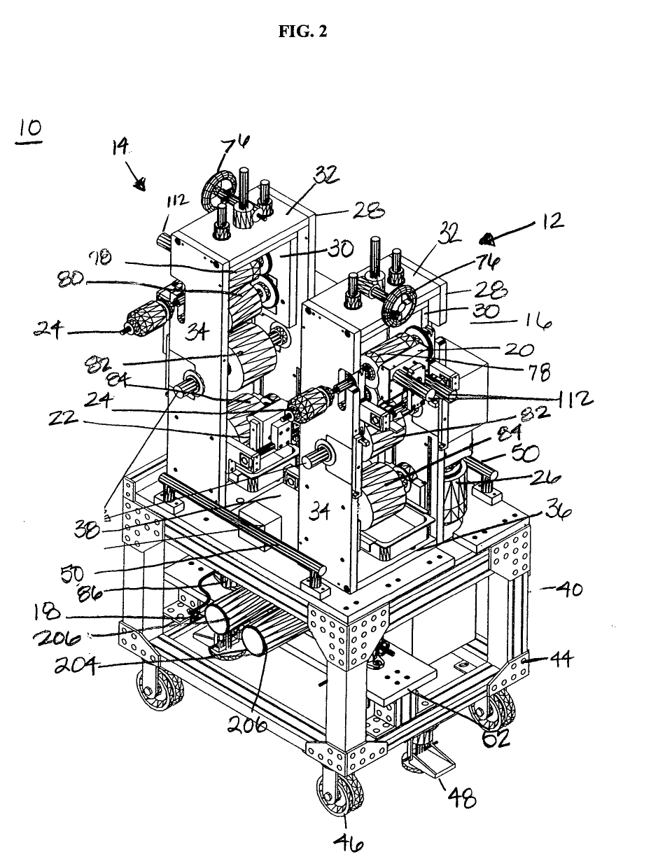

Referring to the drawings in greater detail, FIGS. 1 and 2 show an exemplary embodiment of the instant invention of a machine, 10, for coloring, embossing and printing generally elongated or planar articles including two opposing roller assemblies, 12 and 14, a roller assembly frame unit 16, an operator control panel 15 for controlling operation of machine 10, an electrical panel 17 for supplying power to machine 10, and a lifting mechanism 18.

Roller assembly 12 includes generally the same components, and is constructed in generally the same manner as roller assembly 14, with the exception being that roller assembly 12 is assembled and positioned on machine 10 so as to virtually mirror roller assembly 14. For purposes of simplicity, the components of both roller assemblies are discussed in detail with reference primarily to a single roller assembly, with like numbers referring to the same or similar components on both roller assemblies 12 and 14. It will be appreciated that although machine 10 includes two generally similar roller assemblies, a machine with more than or less than two roller assemblies, or a machine in which the shapes, sizes and arrangement of roller assemblies 12 and 14 vary from one another, is also contemplated to be within the scope of the instant invention. It will further be appreciated that roller assemblies 12 and 14 may be arranged together such that a single slat winds its way through both roller assemblies 12 and 14 to complete the coloring, embossing, and/or printing process, or alternatively, rollers assemblies 12 and 14 may be arranged to work independent from one another.

Each of roller assemblies 12 and 14 includes a frame unit 16 supporting a plurality of rollers, an optional doctor blade subassembly 20 that may be used in connection with coloring roller, and an optional felt-wiper subassembly 22 that may be associated with a discharge roller. Roller assemblies 12 and 14 are each powered by an air motor 24 and a gear motor 26.

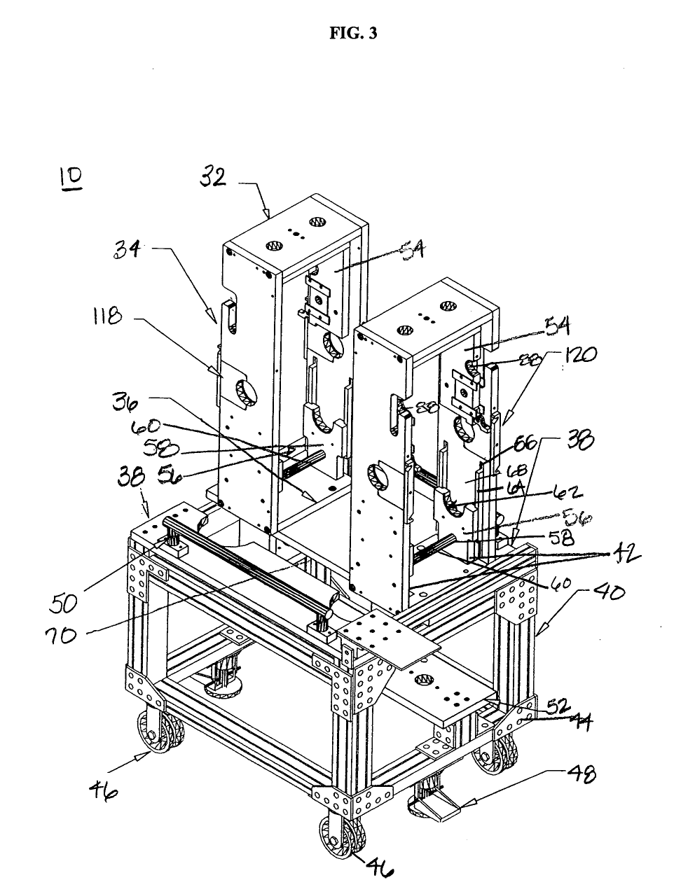

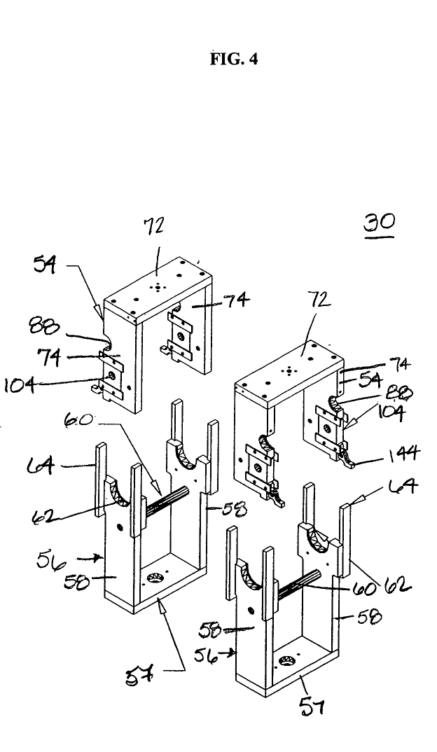

Referring to FIGS. 3 and 4, frame units 16 for roller assemblies 12 and 14 each includes a fixed outer frame 28 and a two-piece adjustable roller support frame 30. As is shown in FIG. 3, the outer support frame 28 for each of roller assemblies 12 and 14 includes a top plate 32 connected to side plates 34 that are mounted to a bottom plate 36. Bottom plate 36 is mounted to a stand base plate 38 that is mounted on the top of a machine base 40. Side plates 34 may also be attached to bottom plate 36 in order to provide additional structural support to outer frame 28 of roller assembly 12 or 14. Bottom plate 36 and base plate 38 include cutouts 42 that are configured to allow portions of roller support frame 30 to extend through bottom plate 36 and base plate 38 to allow for vertical adjustment of roller support frame 30. Machine base 40 also includes a framework 44 to which casters 46 are attached for moving machine 10, and to which floor locks 48 are attached for securing machine 10 in position during operation. Handles 50 may be attached to base plates 38 for grasping machine 10 while it is being moved. Lift plate 52 is also attached to framework 44 of machine base 40 for supporting lifting mechanism 18.

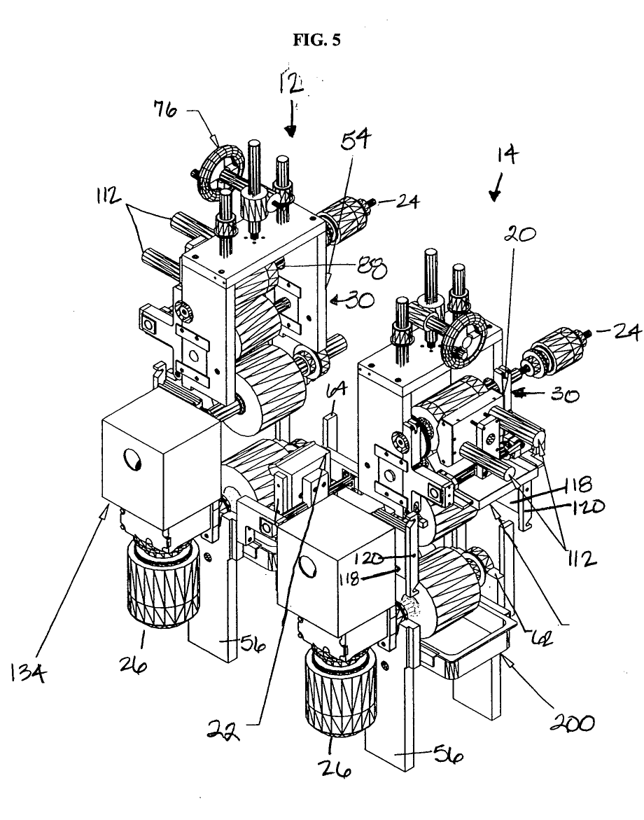

Adjustable roller support frame 30 of each roller assembly 12 and 14 fits within the fixed outer frame 28 described above. As is shown in greater detail in FIG. 4, each adjustable roller support frame 30 includes a top portion 54 and a bottom portion 56. This two-piece design allows top portion 54 and bottom portion 56 to each be adjusted vertically independent of one another. Bottom portion 56 includes a bottom plate 57 coupled to two side plates 58 coupled together with a cross bar 60. Side plates 58 include a roller cradle 62 for supporting a roller and slide bars 64. Slide bars 64 fit and are slidable up and down within grooves 66 that are cut into the inner faces 68 of side plates 34 of outer support frame 28. Sides plates 34 extend through bottom plate 36 and base plate 38 to sit on top of an adjusting plate 70 that is vertically adjustable by lifting mechanism 18 located on lifting unit support plate 52. Top portion 54 of the internal roller support frame 30 includes top plate 72 connected to two side plates 74. As is shown in FIG. 5, top plate 72 is also connected to a height adjustment mechanism 76 configured to control vertical adjustment of top portion 54 relative to top plate 32 of outer frame 28.

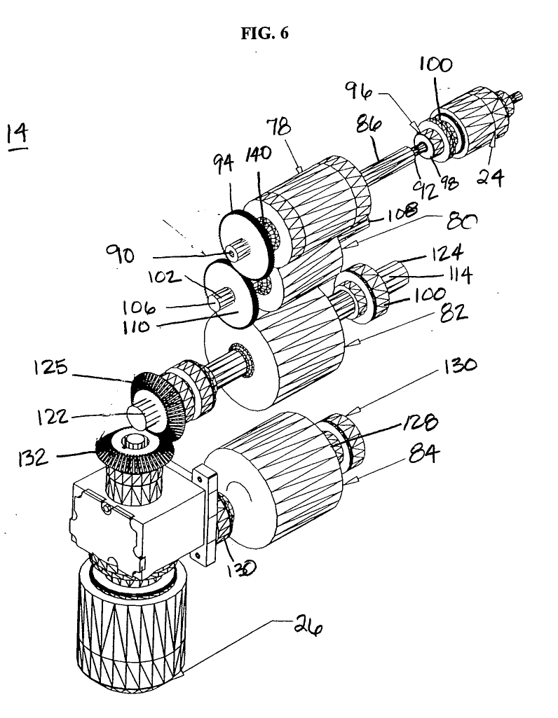

Referring to FIGS. 5 and 6, the arrangement of adjustable roller support frame 30, portions 54 and 56 in connection with the rollers it supports is shown. FIG. 5 shows portions 54 and 56 with rollers installed, and FIG. 6 shows the arrangement of rollers of roller assembly 14 in detail with outer frame 28 being removed. As is shown in FIG. 6, roller assembly 14 includes a first roller 78, a transfer roller 80, a second roller 82, and a third roller 84. Each of rollers 78, 80, 82, and 84 are generally cylindrical and have a central bore therethrough configured to receive a shaft for rotating the roller. Rollers 78, 80, 82 and 84 may be of various sizes and widths depending upon the type of roller being used and its purpose. First roller 78 may be a coloring roller such as an anilox roller or it may be a gravure printing roller. If roller 78 is a coloring roller, it is used to apply a colorant such as ink or paint to the article being colored. A variety of colorants may be used including, but not limited to, water-based or solvent-based inks. If roller 78 is a gravure printing roller, it is used to create designs on the article such as a wood grain design, flower design, stripes, or the like. Roller 78 is supported within top portion 54 of the inner support frame 30 by a shaft 86 removably extending through roller 78 and configured to be received within bearing supports 88 which are generally half-moon shaped cutouts in side plates 74. Shaft 86 includes a first end 90 and a second end 92. A spur gear 94 is operably coupled to shaft 86 proximate first end 90. A support bearing 96 having a first face 98 and a second face 100 is operatively coupled to second end 92 at first face 98. Second face 100 is operatively coupled to air motor 24 for rotation of roller 78 by turning shaft 86. Air motor 24 may be disposed externally to outer frame 28 or it may be supported by a frame (not shown).

Transfer roller 80 is configured to transfer colorant if roller 78 is a coloring roller or a design if roller 78 is a gravure printing roller by rotatably contacting roller 78 such that the colorant or design is transferred onto transfer roller 80. Transfer roller 80 then transfers the colorant or design directly to an article. Transfer roller 80 is supported within top portion 54 of support frame 30 by a shaft 102 removably extending through roller 80 and configured to be received within bearing supports 104 which are generally circular cutouts in side plates 74 and have a diameter larger than that of shaft 102. Shaft 102 includes a first end 106 and a second end 108. A spur gear 110 is operably coupled to shaft 102 proximate first end 106. Rollers 78 and 80 may be vertically adjustable as a single unit within top portion 54. Spur gears 94 and 110 operably engage one another such that transfer roller 80 is rotated by air motor 24 at a rate directly proportional to the rate of rotation of first roller 78. A colorant, such as ink or paint is applied to roller 78 through ink ports 112 that may be located in doctor blade assembly 20 as roller 78 rotates. Doctor blade assembly 20 ensures that any ink in excess of a desired amount is removed from roller 78. The metered amount of ink is then dropped onto transfer roller 80 as it rotatably contacts roller 78 during rotation by air motor 24.

Second roller 82 may be another transfer roller or it may be an embossing roller for embossing patterns or designs onto the desired article. Second roller 82 is not vertically adjustable and is supported within outer frame 28 by a shaft 114 removably extending through roller 82 and configured to be received within supported by bearing supports 116 which are generally circular cutouts in side plates 34 and have a diameter larger than shaft 114. Alternatively, bearing supports 116 may be removably positioned within side plates 34 by insert bearing covers 118. Removable bearing covers 118 are held in position by locking bars 120. Shaft 114 includes a first end 122 and a second end 124. A sprocket gear 125 is operably coupled to shaft 114 proximate first end 122 and a bearing 100 is coupled to shaft 114 proximate second end 124.

Third roller 84 is supported within bottom portion 56 of support frame 30 by a shaft 128 removably extending through roller 84, having bearings 130 on either end, and configured to be received and supported by roller cradle 62. As bottom portion 56 of roller support frame 30 is adjusted vertically, so is third roller 84. Felt-wiper subassembly 22 is associated with third roller 84 to remove any ink that is deposited on roller 84 by an article that has been colored by transfer roller 80. Third roller 84 is operably connected to a sprocket gear 132 which is operably connected to gear motor 26. Gear motor 26 is mounted to the outer surface of side plate 58. Sprocket gears 125 and 132 operably engage one another such that second roller 82 is rotated by gear motor 26 at a rate directly proportional to the rate of rotation of third roller 84. A gear cover box 134 is placed over sprocket gears 125 and 132 to minimize operator exposure to the gears. Lift mechanism 18 controls the vertical adjustment of transfer roller 80 relative to second roller 82 so that the pressure between transfer roller 80 and second roller 82 may be adjusted to an amount desirable to achieve the desired coloring effect on the article.

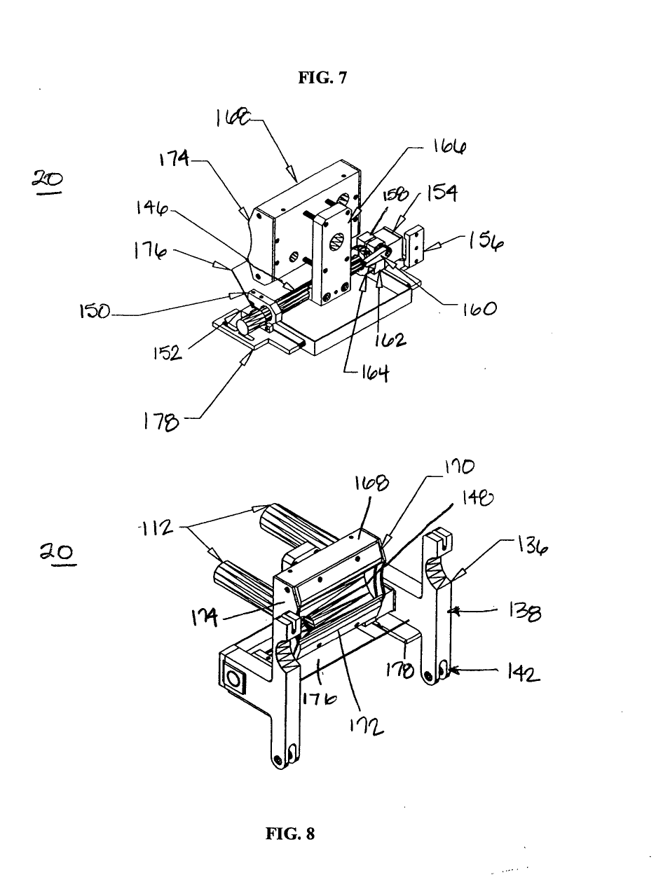

Referring to FIGS. 7 and 8, optional doctor blade assembly 20 shall be described in further detail. Doctor blade assembly 20 is mounted to top portion 54 of roller support frame 30 such that a top section 136 of a pivot support 138 of blade assembly 20 aligns with bearing supports 88 of frame top portion 54 to enclose fully a bearing 140 connected to shaft 86 of first roller 78. Bottom section 142 of pivot support 138 is rotatably mounted to pivot support mounts 144 disposed proximate the bottom of frame top portion 54 to rotate outward and downward away from first roller 78. Doctor blade assembly 20 is connected to top portion 54 of the roller frame support 30 such that assembly 20 will adjust vertically along with top portion 54. When pivot support 138 is in its assembled position (as is shown in FIG. 5), first roller 78 and transfer roller 80 are secured within frame top portion 54. When pivot support 138 and assembly 20 are rotated downward, rollers 78 and 80 can then be removed. Pivot 146 is connected to pivot support 138 for rotational adjustment of a doctor blade 148 relative to pivot support 138. Stop blocks 150 and adjustment blocks 152 are located with pivot blocks 154, which are supported within pivot support 138 by end plates 156 to connect pivot 146 to pivot support 138. Stop block 150 is connected to pivot 146 to limit the rotation of pivot 146 relative to pivot support 138. Adjustment block 152 connects pivot 146 to pivot support 138 to provide horizontal adjustment of doctor blade 148 relative to first roller 78. A clamp 158 is attached to pivot block 154 and includes a clamp handle 160 and a lockdown bar 162. Clamp handle 160 rotates to press lockdown bar 162 against pivot 146 to prevent undesired rotation of pivot 146 during operation. Clamp collar 164 holds clamp 158 tight against pivot block 154.

Pivot arm 166 is connected to pivot 146 for rotation with pivot 146. Wiper blade holder 168 is connected to pivot arm 166. Upper wiper blade 170 is attached to the top of wiper blade holder 168, and a lower wiper blade 172 is attached to the bottom of wiper blade holder 168. Side strips 174 are connected to wiper blade holder 168 and extend downward from each side of upper wiper blade 170 and lower wiper blade 172. In the embodiment shown, upper wiper blade 170 and lower wiper blade 172 both have a length generally equal to, or slightly greater than the axial length of first roller 78, such that upper wiper blade 170, lower wiper blade 172, and side strips 174 partially enclose a portion of first roller 78. Ink is injected into the enclosed area and onto first roller 78 through ink ports 112. As roller 78 rotates, upper wiper blade 170 (or lower wiper blade 172, depending upon the direction of rotation) scrapes excess ink away from full cells or design patterns of first roller 78, evenly spreading the ink to all cells or appropriate portions of the roller, and allowing any remaining ink to drip into pan 176 which is held to pivot support 138 by pan rails 178. Side strips 174 prevent excess ink from building up on the ends of first roller 78. Although upper wiper blade 170 and lower wiper blade 172 in the shown embodiment of the instant invention both have a length equal to or greater than the axial length of roller 78, it will be appreciated that shorter lengths may be utilized such that side strips 174 enclose only the surface of roller 78 instead of extending around the ends of the roller, if the entire axial length of first roller 78 is not to be utilized.

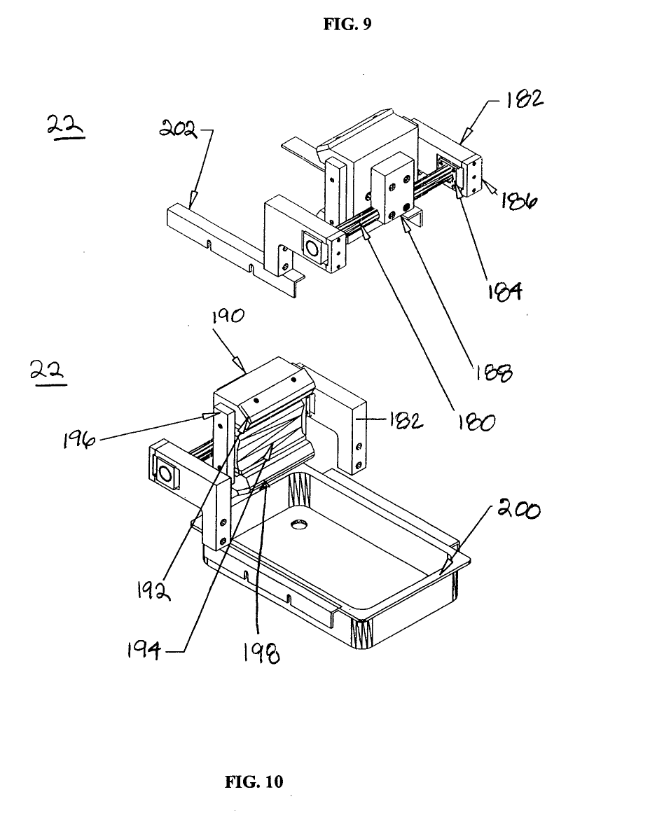

Referring to FIGS. 9 and 10, optional felt-wiper subassembly 22 is described in further detail. Bracket 182 is connected to side plates 58 of bottom portion 56 of roller support frame 30, such that wiper assembly 22 is vertically adjustable along with third roller 84 and bottom portion 56 of roller support frame 30. Pivot 180 is mounted to bracket 182 for rotation relative to bracket 182. Pivot 180 is supported by pivot blocks 184, which are held within bracket 182 by end plates 186. Although not shown in the described embodiment, it will be appreciated that stop blocks, adjustment blocks, and clamps can be utilized in connection with pivot 180 in a manner similar to that described above with respect to pivot 146 for doctor blade assembly 20.

Pivot arm 188 is connected to pivot 180 for rotation along with pivot 180. Holder 190 is connected to pivot arm 188. Holder 190 supports wiper blade 192 and also supports felt insert 194 below wiper blade 192. Side plates 196 are connected to holder 190 to prevent felt insert 194 from sliding sideways out of holder 190. It will be appreciated that felt insert 194 may be a fabric material of matted, compressed animal fibers, such as wool or fur, a fabric of similar materials mixed with vegetable or synthetic fibers, or any other material having suitable ink-retention/absorbent characteristics.

Third roller 84 rotates as elongated or planar articles are fed through machine 10 between third roller 84 and second roller 82. Any excess ink that is deposited on third roller 84 by articles that have been colored is cleaned off of roller 84 by a combination of felt insert 194, top wiper blade 192, and a bottom wiper blade 198 (located below felt insert 194). The bottom of third roller 84 dips into drip pan 200, which is supported to bracket 182 by pan support bracket 202. Any ink that is deposited on third roller 84 is diluted by the water in drip pan 200 (or the water picked up by third roller 84 as it travels through drip pan 200), scraped off by the first wiper blade 192 contacting the surface, scrubbed and further diluted by felt insert 194 and then further scraped by second wiper blade 198 contacting the surface of third roller 84.

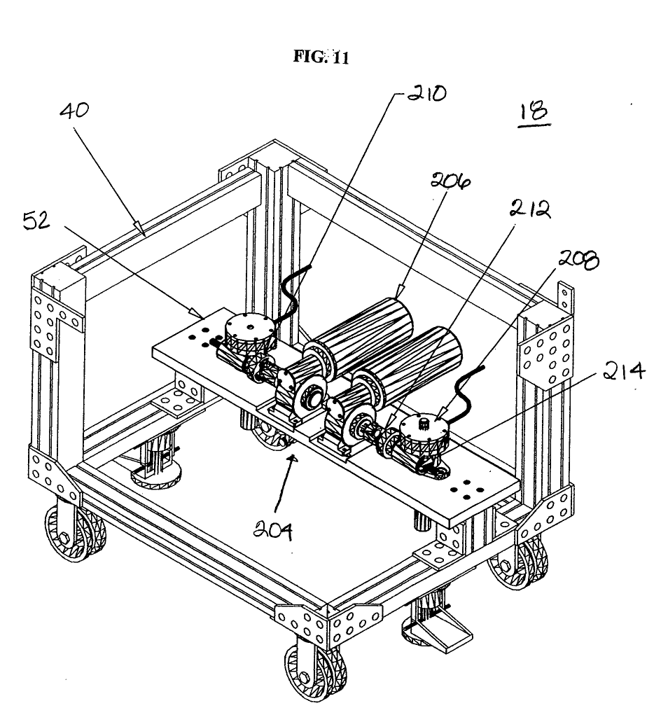

Referring to FIG. 11, the lifting mechanism 18 for vertically adjusting third roller 84 (also roller support bottom portion 56 and felt-wiper assembly 22) for machine 10 is described in further detail. Lift support plate 52 is connected to base 40. Each third roller 84 (one in roller assembly 12 and one in roller assembly 14) is adjusted vertically by a lift assembly 204 that raises and lowers bottom plate 36 of roller support frame 30. Each lift assembly 204 includes a gear motor 206, a load cell 208, a load cell plate 210, a clutch 212, and an actuator 214. When desired to raise and/or lower third roller 84, actuator 214 activates gear motor 206 to move bottom plate 36 accordingly. Load cell 208 indicates the pressure created between third roller 84 and second roller 82 so that third roller 84 may be adjusted to the position necessary to achieve the desired embossing or transfer effect on the elongated or planar article.

Referring to FIG. 1, in operation of machine 10, a generally elongated or planar article such as a polyvinyl chloride window blind slat or profile is fed from an extruder or co-extruder that is disposed near or in line with machine 10. The slat or profile is fed into machine 10 between second roller 82 and third roller 84 of roller assembly 14. The slat or profile is then fed between second roller 82 and third roller 84 of roller assembly 12. The slat or profile is then discharged from machine 10 to a heat box.

It will be appreciated that although machine 10 has been shown and described so as to include two separate coloring/printing and transfer/embossing stages for a single slat or profile, the same machine can also be utilized to provide only one coloring/printing and one embossing stages, one coloring/printing and two embossing stages, two coloring/printing and one embossing stages, two coloring/printing and no embossing stages, one coloring, one printing and no embossing stages, no coloring, one printing stage and one embossing stage, or no coloring, one printing stage and two embossing stages. Machine 10 may be modified to provide one coloring/printing and one embossing stage by replacing second roller 82 with a blank roller. It will also be appreciated that machine 10 may work together with other components and/or machines to complete the coloring, printing and embossing stages. Such additional components/machines include, but are not limited to, extruders, co-extruders, cooling tables, heat boxes, and the like.

The generally elongated or planar articles of the present invention may include such articles as vinyl slats used to manufacture window blinds, molding, baseboards, quarter-rounds, gutters, shutters and the like. One skilled in the art will appreciate that any generally elongated or planar article useful in the home building/improvement, consumer and construction product industries would be suitable for use in the present invention. The article may be formed from a number of materials including wood, metal, thermoplastic resins including polyvinyl chloride (PVC) or similar materials. PVC slats are typically formed by selectively extruding molten PVC material to the desired shape. The article of the present invention may also be formed from polymerized thermoplastics with cellular structures such as foam polyvinyl chloride, polystyrene or the like. One skilled in the art will appreciate that any material suitable for use in forming the generally elongated or planar articles of the present invention may be used. Particularly preferred materials, including those discussed above, may have one or more of the following properties: renewable resources, fire retardant, recyclable, better insulation properties than wood, and better sound-deadening properties than wood.

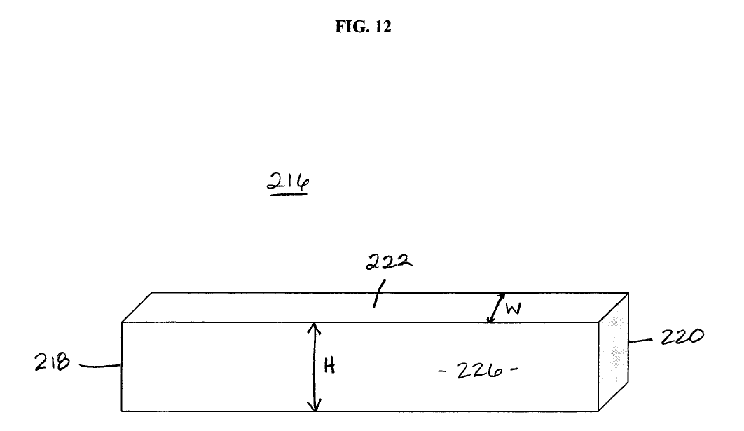

Referring now to FIG. 12, the article 216 of the present invention includes a first end 218 and a second end 220. Article 216 also includes a height (H) and a width (W). Height (H) extends between a first surface 222 and an oppositely disposed second surface 224. Width (W) extends between a third surface 226 and an oppositely disposed fourth surface 228. Height (H) may range from as little as 1 mm to up to about 125 mm or any range therebetween. Width (W) may range from as little as 5 mm to up to about 300 mm or any range therebetween. It will be appreciated by those skilled in the art that article 216 may have any shape including, but not limited to, flat, round, quarter-moon, half-moon, C-shaped, U-shaped, annular, arched, beveled, chamfered, channels, concave, convex, notched, rectangular, tubular, or any other shape suitable for use the home building/improvement, consumer and construction product industries.

In one embodiment, using machine 10 described above, article 216 may be extruded and then fed from the extruder disposed near or in line with machine 10 between second roller 82 and third roller 84 of roller assembly 14. Article 216 is then fed between second roller 82 and third roller 84 of roller assembly 12. If first roller 78 is a coloring roller, color is transferred from first roller 78 onto transfer roller 80. Transfer roller 80 then transfers the color onto third roller 84 which could be an embossing roller or blank roller. The color is then transferred from third roller 84 onto first surface 222 of article 216. Article 216 continues to between third roller 84 and second roller 82 of roller assembly 12. If either or both of second roller 82 or third roller 84 is an embossing roller, first and/or second surface of article 216 is embossed with a design or pattern such as a simulated wood grain that gives texture to article 216. Article 216 then continues to between third roller 84 and second roller 82 of roller assembly 14. Second roller 82 may also emboss a design onto article 216 or it may act as a transfer roller if first roller 78 of roller assembly 12 is a coloring roller or a printing roller. Article 216 is then discharged from machine 10 to a heat box where it is cured to produce a colored and embossed generally elongated or planar article 216. In another embodiment, first roller 78 is a printing roller that prints a design such as a wood grain pattern or a floral motif onto article 216. Article 216 may then be colored, and embossed as described above via movement from roller assembly 14 to roller assembly 12.

Thus, depending upon the types of rollers used in roller assemblies 12 and 14, article 216 may be colored, embossed and printed using machine 10. As discussed above, any combination of rollers may used thereby delivering an article 216 that is only colored, only embossed, only printed, or any combination of the three. It will also be appreciated by those skilled in the art that article 216 may be colored, embossed, and/or printed on either or both of first surface 222 and second surface 224. Moreover, it is contemplated that third surface 226, and fourth surface 228 may also colored, embossed and/or printed. Thus, article 216 may have color, embossing, and/or printing on all four surfaces 222, 224, 226, and 228 thereby increasing its aesthetic value and durability.

Although the foregoing detailed description of the present invention has been described by reference to an exemplary embodiment, and the best mode contemplated for carrying out the present invention has been shown and described, it will be understood that modification or variations in the structure and arrangement of this embodiment other than those specifically set forth herein may be achieved by those skilled in the art and that such modifications are to be considered as being within the overall scope of the present invention. Therefore, it is contemplated to cover the present invention and any and all modifications, variations, or equivalents that fall within the true spirit and scope of the underlying principles disclosed and claimed herein. Consequently, the scope of the present invention is intended to be limited only by the attached claims.

What is claimed is:

1. An apparatus for coloring or printing generally elongated or planar objects comprising:
a first roller rotatably connected to a support frame; and
a second roller rotatably connected to said support frame and located in series with said first roller;
wherein said first roller is selected from the group consisting of anilox rollers and gravure printing rollers; and
wherein said second roller is selected from the group consisting of embossing rollers, transfer rollers, and blank rollers.

2. The apparatus of claim 1 further comprising a transfer roller disposed between said first roller and said second roller and located in series with said first roller.

3. The apparatus of claim 2 further comprising a third roller located in series with said second roller.

4. The apparatus of claim 3, said third roller being selected from the group consisting of embossing rollers, discharge rollers, and blank rollers.

5. The apparatus of claim 4 further comprising a wiper unit assembly for said discharge roller, said wiper unit assembly comprising a discharge roller wiper blade having a length generally corresponding to a length of said discharge roller and a felt surface generally adjacent said discharge roller wiper blade.

6. The apparatus of claim 1 further comprising a doctor blade assembly connected to said support frame, said doctor blade assembly comprising a wiper blade having a length generally corresponding to a length of said first roller, a first side strip adjacent a first end of said wiper blade, and a second side strip adjacent a second end of said wiper blade wherein said second end opposes said first end.

7. The apparatus of claim 1 wherein said first roller is interchangeable and easily removed from said support frame.

8. The apparatus of claim 1 wherein said second roller is interchangeable and easily removed from said support frame.

9. The apparatus of claim 1 further comprising a plurality of apparatuses in line with said apparatus configured to color, print or emboss said object without substantial interruption between said apparatuses.

10. The apparatus of claim 9 wherein a first roller of a first apparatus is an anilox roller and a first roller of a second apparatus is a gravure printing roller.

11. A method for coloring generally elongated or planar objects comprising: applying colorant to a first roller;
scraping excess colorant from an outer surface of said first roller with a doctor blade;
enclosing at least a portion of said first roller during said applying and scraping steps; and
transferring the colorant from said first roller to an object.

12. The method of claim 11, said transferring step further comprising the steps of contacting said first roller with a transfer roller to receive said colorant from said first roller, and contacting a surface of the object with said transfer roller to transfer said colorant to said object.

13. A method for coloring and printing a generally elongated or planar object comprising the steps of:
providing a first apparatus having an anilox roller;
providing a second apparatus having a gravure printing roller;
applying color to said anilox roller and to said gravure printing roller;
contacting said object with said anilox roller;
transferring said color from said anilox roller to said object;
contacting said object with said gravure printing roller; and
transferring said color from said gravure printing roller to said object.

14. The method of claim 13 further comprising an embossing roller located in series with said anilox roller.

15. The method of claim 14 further comprising the steps of contacting said object with said embossing roller and embossing a design onto said object.

16. The method of claim 13 further comprising an embossing roller located in series with said gravure printing roller.

17. The method of claim 16 further comprising the steps of contacting said object with said embossing roller and embossing a design onto said object.

18. The method of claim 13 further comprising the steps of removing and replacing said anilox roller with a gravure printing roller.

19. The method of claim 13 further comprising the steps of removing and replacing said gravure printing roller with an anilox roller.

20. The method of claim 14 further comprising the steps of removing and replacing said embossing roller with a transfer roller.

21. The method of claim 16 further comprising the steps of removing and replacing said embossing roller with a transfer roller.

22. A generally elongated or planar article comprising:
a first end;
a second end;
a first surface; and
a second surface oppositely disposed thereto;
wherein said first surface includes a treatment thereon selected from the group consisting of coloring, embossing, printing, and combinations thereof; and
wherein said second surface includes a treatment thereon selected from the group consisting of coloring, embossing, printing, and combinations thereof.

23. The article of claim 22 further comprising a third surface having a treatment thereon selected from the group consisting of coloring, embossing, printing, and combinations thereof.

24. The article of claim 23 further comprising a fourth surface oppositely disposed from said third surface, said fourth surface having a treatment thereon selected from the group consisting of coloring, embossing, printing, and combinations thereof.

25. The article of claim 22, said first and second ends having a treatment thereon selected from the group consisting of coloring, embossing, printing, and combinations thereof.

26. The article of claim 22 further comprising a height extending between said first surface and said oppositely disposed second surface.

27. The article of claim 22 further comprising a width extending between said third surface and said oppositely disposed fourth surface.

28. The article of claim 25, said height being from about 1 mm to about 125 mm.

29. The article of claim 26, said width being from about 5 mm to about 300 mm.

30. The article of claim 22, said article being composed of a material selected from the group consisting of wood, metal, thermoplastic resins, polymerized thermoplastic resins, and mixtures thereof.

31. The article of claim 22, said article having a shape selected from the group consisting of flat, round, quarter-moon, half-moon, C-shaped, U-shaped, annular, arched, beveled, chamfered, channels, concave, convex, notched, rectangular, and tubular.
